(19) United States
(12) Patent Application Publication
(10) Pub. No.: US 2004/0049686 A1
(43) Pub. Date: Mar. 11, 2004

(54) Fingerprint identification applied data storage system and method

(76) Inventors: Chun-Yu Chen, Taipei (TW); Nien-Tsu Chen, Taipei (TW)

Correspondence Address: BIRCH STEWART KOLASCH & BIRCH, PO BOX 747, FALLS CHURCH, VA, 22040-0747, US

(21) Appl. No.: 10/234,190

(22) Filed: Sep. 5, 2002

(51) Int. Cl. H04L 9/32

(52) U.S. Cl. 713/186

(57) ABSTRACT

A kind of data storage system and method with applied fingerprint identification is disclosed herein. A user is able to access data in a data storage device through a connected PC terminal after s/he passes through user identity recognition by a built-in fingerprint identification module of the data storage device, which is externally connected with the PC terminal.

### BACKGROUND OF THE INVENTION

1. Field of Invention

The invention relates to a data access (storage/retrieval) system and method. More particularly, it is a kind of system and method applied to a plug and play (PnP) portable data storage device utilizing fingerprint identification technology for processing confirmation of user identification. Moreover, it is a system and method that provides the mechanism of biometric control.

2. Related Art

With the coming of the age of mobile commerce, mobile commodities such as mobile phones, hand-held personal digital assistants (PDA) and portable laptops emphasize the need for small and lightweight size, full-functions and portability. The development of these personal mobile commodities does not remain stagnant, but make great progress toward pluralistic applications. One of the hottest topics among currently developing mobile commodities is the portable data storage device, which, relying on its convenience of usage to users, plays an indispensable role in today's mobile commerce and further creates another new trend in the m-commerce world.

For providing the function of complete convenience of usage, currently used portable data storage devices usually employ their PnP characteristic to enable users to easily connect with another PC terminal for further data access. Therefore, there is no particular prevention mechanism for controlling data security. Some portable data storage devices apply data methods such as encrypting, encoding and compressing during data storage to prevent data from being obtained from others in case the device is lost or misplaced. These methods maintain some security, but they still cause considerable inconvenience for users accessing data. For instance, it is inefficient for a user to have to pass through complicated data procedures like decrypting, decoding, decompressing, and strict mechanisms of declassifying passwords before s/he is allowed to retrieve the required data. There have been some troublesome problems of conventional password mechanisms hindering users from data access work, such as having the same passwords as others, passwords being forgotten and/or stolen, etc. This causes inconvenience to a user, as s/he needs to memorize groups of passwords that correspond to various password mechanisms. It also causes a user to be unwilling to use portable data storage devices and decreases their popularity in the market.

Therefore, utilizing advanced computer software/hardware technology with current portable data storage devices with matured and simplified identity recognition technology to establish a complete and secure data access control mechanism of the portable data storage devices will heighten usage willingness and popularization of portable data storage devices.

### SUMMARY OF THE INVENTION

In view of the aforementioned problems, the object of the invention is to provide a data storage system and method with fingerprint identification technology. The invention aims at establishing the security control mechanism of data access on a plug and play (PnP) portable data storage device and increasing the security of data access through biometric fingerprint identification technology.

The invention also aims at solving the inconvenience of password methods by utilizing simplified fingerprint identification technology to replace conventional complicated password mechanisms.

To achieve the aforementioned objects, the disclosed data storage system and method with fingerprint identification consists of: a data storage module, a transmission interface module, a fingerprint identification module, and a control module.

Furthermore, the data storage system and method with fingerprint identification technology consists of the following steps: firstly, connecting the data storage device with a PC terminal, processing a self-test by the data storage device to enter into a receiving/inputting mode, receiving a fingerprint-sensed image for executing the identification operation, transferring a control command to allow access transfer after the identification operation is completed, and finally, processing the corresponding transfer of selected data by the user through the said transmission interface.

The detailed content and technology of the invention is depicted by the following figures and descriptions.

### BRIEF DESCRIPTION OF THE DRAWINGS

FIG. 1 is the systematic structure of the disclosed data storage system and method with fingerprint identification technology according to the invention;

FIG. 2 is the main flowchart of the disclosed data storage system and method with fingerprint identification technology; and

FIG. 3 is the flowchart for identifying authorization of the disclosed data storage system and method with fingerprint identification technology.

### DETAILED DESCRIPTION OF THE INVENTION

The invention is a kind of data storage system and method with applied fingerprint identification technology. It applies fingerprint identification to the data storage device 200, which connects to an external PC terminal 100 for identity recognition. It enables a user to process data transfer from the data storage device 200 via the connected PC terminal 100 after the user passes through the identity recognition operation.

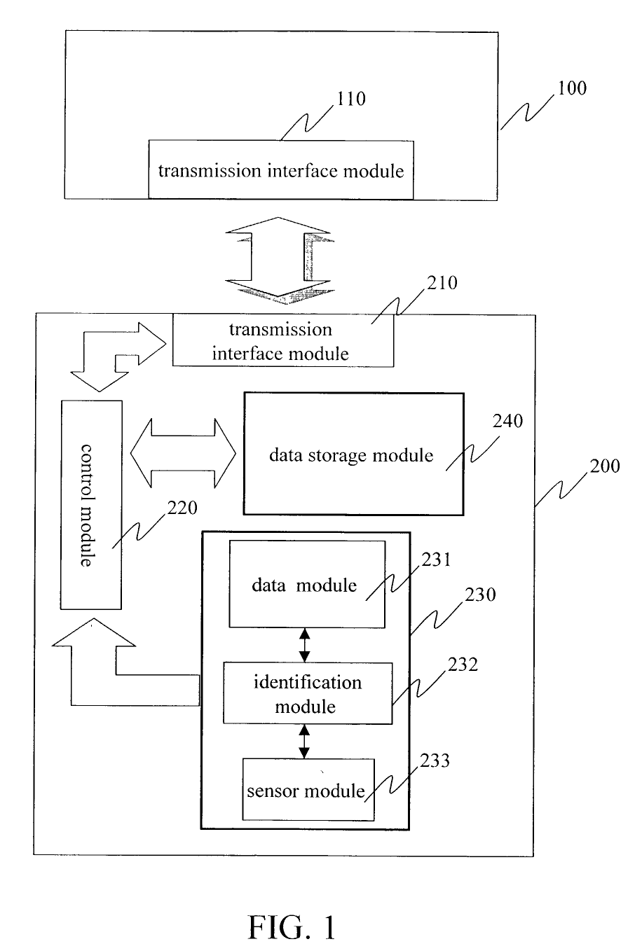

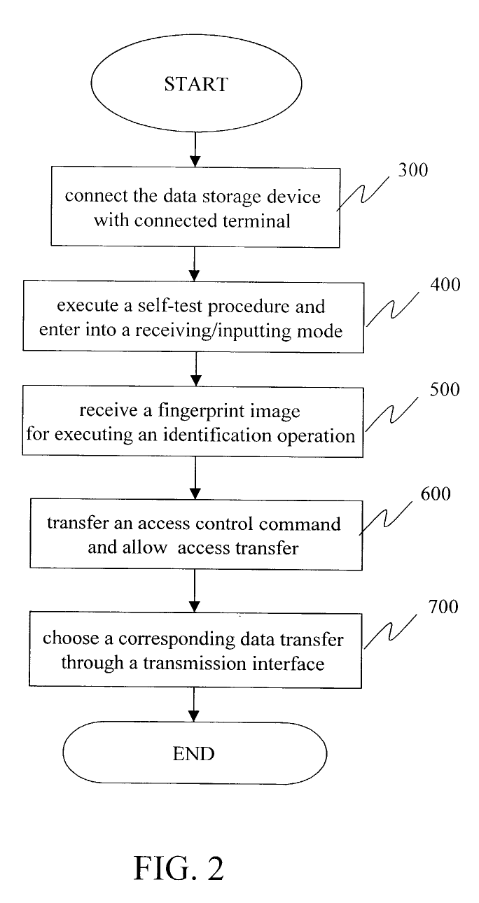

The operational flowchart is shown in FIG. 2, which illustrates the main flow of the disclosed data storage system and method. The systematic structure of the process is depicted in FIG. 1, which illustrates the systematic structure of the disclosed data storage system and method. Details are provided as follows:

First, the data storage device 200 must connect with another connected PC terminal 100 (step 300) before a user can process data access from the data storage device 200. After connection, the data storage device 200 automatically performs a self-test procedure to ensure that the connection between the data storage device 200 and the said PC terminal 100 works. The self-test procedure consists of the operational tests of a transmission interface module 210, a control module 220, and a fingerprint module 230. If there is any abnormal situation during the self-test procedure, the data storage device 200 automatically displays relevant error messages to the user; otherwise, the fingerprint module 230 enters into the receiving/inputting mode to wait for inputting fingerprint data by the user (step 400). The user then processes the fingerprint-sensed input on the sensor module 233 of the fingerprint module 230. After receiving the fingerprint from the user, the system carries out the identification process through an identification module 232 of the fingerprint module 230 (step 500), i.e., retrieve stored recognized data from a data module 231 as contrasted with the user's fingerprint data. After the identity recognition process is completed and the user is verified as an authorized user, the fingerprint module 230 further generates an access control command, allowing the user to access data and transferring the message to the control module 220. When the control module 220 receives a command, it automatically starts up the “enable” function for data transfer, and the user is able to access data to the data storage module 240 (step 600). Meanwhile, the user is able to select data content in the data storage device 200 through the PC terminal 100 and process transfer and access of corresponding data through the transmission interface module 210 of the data storage device 200 via the transmission interface module 110 of the PC terminal 100 (step 700). The main flow of processing data access applies fingerprint identification technology to the data storage device 200 and is completed herein.

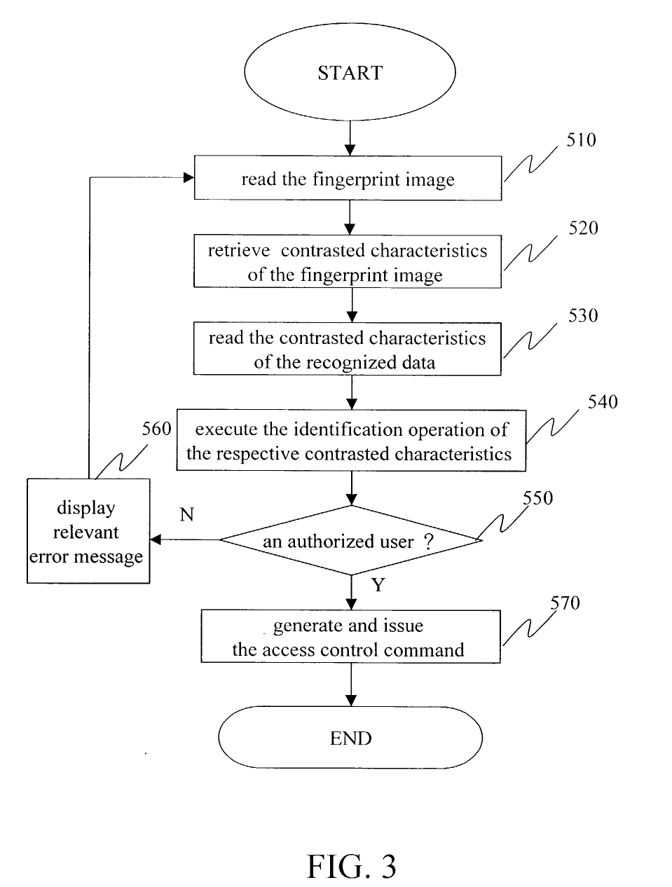

The process of fingerprint identification authorization is further described as shown in FIG. 3. The details are as follows.

Firstly, the identification module 232 retrieves an inputted fingerprint image through the sensor module 233 (step 510). The characteristic of the inputted fingerprint image are retrieved through fingerprint identification technology (step 520), and stored identification data in the data module 231 is also retrieved (step 530) for processing the characteristic contrasts (step 540). After the identification process is completed, the identification module verifies if the user is an authorized user (step 550). If NO, it shows relevant error message (step 560) to the user; otherwise, it generates an access control command to the control module 220, allowing the user to process data access (step 570).

### Achievements of the Invention

The present invention is a kind of a data storage system and method with applied fingerprint identification technology. It applies to plug and play (PnP) portable data storage devices utilizing fingerprint identification technology for processing user identity recognition. It increases security and confidentiality of stored data in the data storage devices through the unique fingerprint identification data.

Furthermore, the invention largely simplifies conventional recognition procedures of using passwords to verify user identity. Therefore a user does not need to waste time memorizing password data in respective applied systems, and does not need to worry about possible password stealing and exposure, which have a huge impact on the security of data storage.

An invention in the form of a data storage system and method with applied fingerprint identification technology is disclosed herein; however, it is to be understood that the disclosed embodiments are merely exemplary of the invention that may be embodied in various forms. This and its variations, which will be understood by those skilled in the art, are within the intended scope of the invention as claimed below.

What is claimed is:

1. A kind of data storage system and method with applied fingerprint identification technology utilizes fingerprint identification technology, while a data storage device connects to an external PC terminal, for recognizing a user identity, and enables the PC terminal to proceed data access in the data storage device, the system comprises:
a data storage module, which stores a specific user's data content;
a transmission interface module, which carries out data transfer of the data storage module;
a fingerprint identification module, which receives a fingerprint image for carrying out the identification operation, generates an access control command to proceed access to stored data, further comprises:
a sensor module, which receives a fingerprint image and transfers it for identification;
a data module, which stores recognized data of the authorized user for proceeding identification; and
an identification module, which retrieves the characteristic of the fingerprint image as contrasted with stored recognized data of the data module for proceeding the identification operation; and
a control module, which proceeds a self-test procedure for the data storage device, controls transfer of data access message and enables the control of access function for data transfer, according to a generated access control command.

2. The invention as recited in claim 1, wherein the said data storage device is a plug and play (PnP) portable data storage device and connects the same transmission interface module to proceed data transfer through a data transfer protocol.

3. The invention as recited in claim 1, wherein the PC terminal is a computer hardware with the function of arithmetical operation.

4. The invention as recited in claim 1, wherein the said transmission interface module is selected from the groups of USB1.0, USB2.0 and IEEE1394.

5. The invention as recited in claim 1, wherein the said self-test procedure further consists of an operational test of the transmission interface module, an operational test of the control module and an operational test of the fingerprint identification module.

6. The invention as recited in claim 1, wherein the system further executes relevant error message display when there is any abnormal situation during the self-test.

7. A kind of data storage system and method with applied fingerprint identification technology, while a data storage device connects to an external PC terminal, for recognizing a user identity, and enables the PC terminal to proceed data access in the data storage device, the said method comprises the following steps:
connecting the data storage device with the PC terminal;
executing a self-test procedure and entering into a receiving/inputting mode;
receiving a fingerprint image for executing an identification operation;
transferring an access control command and allowing a access transfer; and
selecting the corresponding access item for transferring through a transmission interface

8. The invention as recited in claim 7, wherein the data storage device is a plug and play (PnP) portable data storage device and connects the same transmission interface module to proceed data transfer through a data transfer protocol.

9. The invention as recited in claim 7, wherein the said PC terminal is a computer hardware with the function of arithmetical operation.

10. The invention as recited in claim 7, wherein the said transmission interface module is selected from the groups of USB1.0, USB2.0 and IEEE1394.

11. The invention as recited in claim 7, wherein the said self-test procedure further consists of an operational test of the transmission interface module, an operational test of the control module and an operational test of the fingerprint identification module.

12. The invention as recited in claim 7, wherein the said method further consists of the steps of executing the self-test procedure and entering into a receiving/inputting mode, so that it displays relevant error messages while there is an abnormal situation during the self-test.

13. The invention as recited in claim 7, wherein the step of receiving a fingerprint image for executing an identification operation further consists of the following steps, reading the fingerprint image;
retrieving a contrasted characteristic of the fingerprint image;
reading the contrasted characteristic of the recognized data;
executing the identification operation of respective contrasted characteristic; and
generating and issuing the access control command.

14. The invention as recited in claim 13, wherein the said step of executing the identification operation of respective contrasted characteristic further consists of a step of displaying relevant error messages while the fingerprint image belongs to an authorized user.
